(19) United States
(12) Patent Application Publication
(10) Pub. No.: US 2021/0168472 A1
(43) Pub. Date: Jun. 3, 2021

(54) AUDIO VISUAL TIME BASE CORRECTION IN ADAPTIVE BIT RATE APPLICATIONS

(71) Applicant: ARRIS Enterprises LLC, Suwanee, GA (US)

(72) Inventors: Joseph Wilson Monaco, Cary, NC (US); Charles A. Zimmerman, Mount Laurel, NJ (US)

(73) Assignee: ARRIS Enterprises LLC, Suwanee, GA (US)

(21) Appl. No.: 17/108,113

(22) Filed: Dec. 1, 2020

Related U.S. Application Data
(60) Provisional application No. 62/942,167, filed on Dec. 1, 2019.
(60) Provisional application No. 63/079,346, filed on Sep. 16, 2020.

(51) Int. Cl. H04N 21/845; H04N 19/152; H04N 19/172

(52) U.S. Cl. CPC H04N 21/8456; H04N 19/172; H04N 19/152

(57) ABSTRACT

A method and apparatus for resolving timing issues that arise when converting ABR media content to a transport stream by adding or deleting encoded audio/video frames in the to the segments of encoded audio/video frames at the end or beginning of advertisement (ad) transitions is disclosed.

### CROSS-REFERENCE TO RELATED APPLICATIONS

This application claims benefit of U.S. Provisional Patent Application No. 62/942,167, entitled “AUDIO VISUAL TIME BASE CORRECTION IN ADAPTIVE BIT RATE APPLICATIONS,” by Joseph Monaco and Charles Zimmerman, filed Dec. 1, 2019, which application is hereby incorporated by reference herein.

This application also claims benefit of U.S. Provisional Patent Application No. 63/079,346, entitled “AUDIO VISUAL TIME BASE CORRECTION IN ADAPTIVE BIT RATE APPLICATIONS,” by Joseph Monaco and Charles Zimmerman, filed Sep. 16, 2020, which application is hereby incorporated by reference herein.

### BACKGROUND

### 1. Field

The present disclosure relates to systems and methods for transmitting video information, and in particular to a system and method for correcting time base errors when converting from adaptive bit rate video data to conventional bit streams.

### 2. Description of the Related Art

Adaptive Bit Rate (ABR) media delivery protocols such as HLS and DASH decompose media content into a series of uniquely decodable segments that are stitched together by a decoder for presentation. A packager constructs these media segments by ingesting original content and generating independent files along with meta data describing the contents of those files. ABR clients then decode the segments into physical audio and video frames with a playback timeline guided by the meta data in the stream and precise timing information embedded in each audio/video component.

In the simplest ABR systems, the decoder embedded in the client gets all data from the same packager tied to one source; however, there is no guarantee that all the segments received by an ABR client originated from a single source. In particular in the case of ad-splicing, the source for the encoded content can originate from different encoders and/or different packagers. These transitions can lead to timing issues in the presentation caused by a mismatch between the meta data and the actual data in the stream. Due to errors in the packager or poorly encoded media, the segments can be slightly longer or shorter than the indicated segment duration. Although the coding standards do not define precise algorithms, modern decoders can use the timeline embedded in the meta data along with internal timing in the stream to fix minor timing problems in presenting the stream. For example, segments that are too long can have audio/video frames dropped at frame boundaries while gaps in data can be filled with silence or repeated frames. Often these adjustments are imperceptible to the viewer and can occur at any point in the stream.

In legacy media delivery schemes, content is delivered to a receiver over UDP (user datagram protocol) as a continuous stream of data. Such streams typically include a PTS (presentation time stamp) which tell the decoder when to display or present a media access unit in the stream, a DTS (decode time stamp), which tells the decoder when to decode a media access unit in the stream), and a PCR (program clock reference) which is the reference clock for all the PTS/DTS timestamps. The decoder uses PCR timestamps embedded in the transport stream together with the arrival time of those timestamps to lock to the frequency of the source clock. ISO 13818-1 (hereby incorporated by reference herein) provides buffer models and timing requirements that devices must meet to insure glitch free content delivery. Decoder behavior is undefined if these timing/buffer model requirements are not met.

It is desirable to provide seamless media deliver of ABR content to devices such as STBs (set top boxes) via traditional legacy cable/broadcast systems. In such legacy media delivery schemes, content is delivered over UDP as a continuous stream of data. The decoders used with traditional legacy cable/broadcast systems are designed with an expectation on precise timing whereas ABR clients are generally software based and lack dependence on a fixed clock. It is a challenge to supply legacy decoders with MPEG compliant streams from ABR sources. In particular, two problems arise in conversion of ABR content to MPEG compliant UDP. First, ABR segments arrive via http requests rather than as a steady stream of data. The bursty nature of data arrival slows source clock recovery. Second, the PCR clock used in adjacent segments may be completely different. The approach taken here corrects for timing issues introduced by these challenges at splice boundaries in the coded domain to assure that legacy decoders have well defined behavior.

What is needed is a system and method that can implement a time base correction algorithm in the compressed domain to address some timing problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

To address the requirements described above, this document discloses a system and method for correcting a time base of a video stream, the video stream compiled from video data received in a plurality of segments having a plurality of video frames encoded according to an adaptive bit rate protocol. The method comprises receiving a first segment of the plurality of segments, the first segment having a first set of the first plurality of encoded video frames, buffering the received first set of the plurality of encoded video frames in a buffer, providing the buffered first set of the plurality of encoded video frames for processing to compile at least a portion the video stream, receiving a second segment of the plurality of segments, the second segment having a second set of the first plurality of encoded video frames, determining an amount of encoded video frames currently buffered; and adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered before processing the second set of the plurality of encoded video frames to compile at least a second portion of the video stream.

Another embodiment is evidenced by an apparatus having a processor and a communicatively coupled memory storing processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram depicting one embodiment of a content distribution system using an adaptive bit rate protocol;

FIG. 2 is a diagram illustrating a representation of an adaptive bit rate encoded video program;

FIG. 3 is a diagram illustrating one example of the streaming of segments of a media program using an exemplary adaptive bit rate protocol;

FIG. 4 is a diagram of a virtual headend system;

FIG. 5 is a diagram illustrating one embodiment of a method for correcting a time base of an audio/video stream;

FIGS. 6A-6G, which present a diagram of an ABR to TS Converter (ATC) inserting and deleting encoded video frames to account for timing discrepancies; and

FIG. 7 illustrates an exemplary computer system that could be used to implement processing elements of the ATC.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

While video subscribers continue to expand their demands for IP-based video, millions of subscribers continue to rely on legacy STBs receiving transport streams delivered via traditional QAM or quadrature amplitude modulation) techniques. This is performed by a video core, which prepares video for delivery over the access network. Functions performed by the video core include encryption, multiplexing, modulation and techniques to optimize bandwidth as video traverses the network.

Decoders for cable/broadcast used in S1Bs are designed with an expectation on precise timing of the transport streams whereas ABR clients are generally software based and lack dependence on a fixed clock. The challenge is supplying the legacy STB decoders with a perfectly constructed stream, even when that stream is ultimately from an imperfect ABR source. Described below is a technique for correcting timing issues at splice boundaries between segments of the ABR stream in the coded domain such that legacy decoders handling these ABR streams reconstructed into TS stream have well defined behavior, and do not hang or stutter over timing issues. This time base correction technique operates in the compressed domain and can be implemented by any device receiving the ABR stream and converting that ABR stream into a TS or other stream for use by an STB with a standard decoder.

### ABR Content Distribution System

We first begin with a description of an ABR content distribution system and the protocol used for transmission. HTTP Live Streaming (HLS) enables media playback over a network by breaking down a program into digestible segments of media data and providing a means by which the client can query the available segments, download, and render the individual segments. Additionally, HLS provides a mechanism for publishing chunks of varying bitrate and resolution, advertised as the number of bits per second and horizontal/vertical picture dimensions, required to render the media, respectively. Client applications have typically determined the available throughput of the network and selected the highest bitrate available that can be downloaded for the given throughput. However, network throughput or bandwidth is only one of the factors impacting media playback quality. Some media playback sessions are performed by software audio and video decoders providing rendering to, e.g., web browser applications; if these software decoding methods cannot perform real-time decoding of high bitrate variants due to inadequate CPU and/or memory resources, methods are required to limit the maximum bitrate variant retrieved by the client regardless of whether the network supports delivery of higher bitrate/resolution variants.

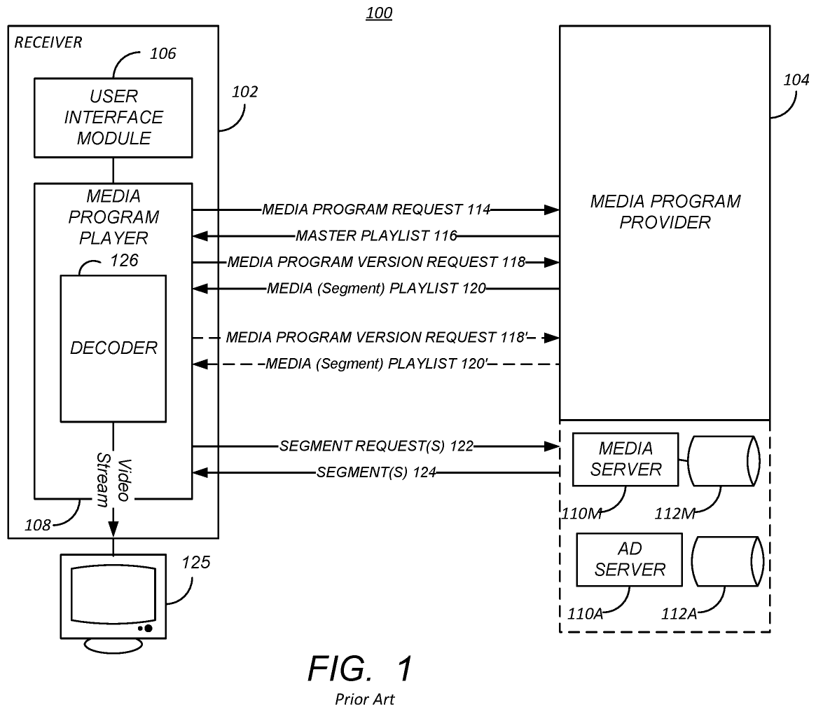

FIG. 1 is a diagram depicting one embodiment of a content distribution system 100 (CDS) using the HLS protocol. The depicted CDS 100 comprises a receiver 102 communicating with a media program provider (MPP)104, also known as a “headend.” The receiver 102 comprises a media program player (MPP) 108 communicatively coupled to a user interface module 106. The user interface module 106 accepts user commands and provides such commands to the MPP 108. The user interface module 106 also receives information from the MPP 108 including information for presenting options and controls to the user and media programs to be displayed. A media server 110 communicatively coupled to storage device 112 provides media programs to the receiver 102 as further described below. As illustrated, the media server 110M and storage 112M and the advertising server 110A and advertising storage 112A may be part of the media program provider 104 or a separate entity such as AKAMAI. The receiver 102 may be embodied in a device known as a set-top-box (STB), integrated receiver/decoder, tablet computer, desktop/laptop computer, or smartphone.

HLS is a technology for streaming on-demand audio and video to receivers 102 such as cellphones, tablet computers, televisions, and set top boxes. HLS streams behave like regular web traffic, and adapts to variable network conditions, dynamically adjusting playback to match the available speed of wired and wireless communications.

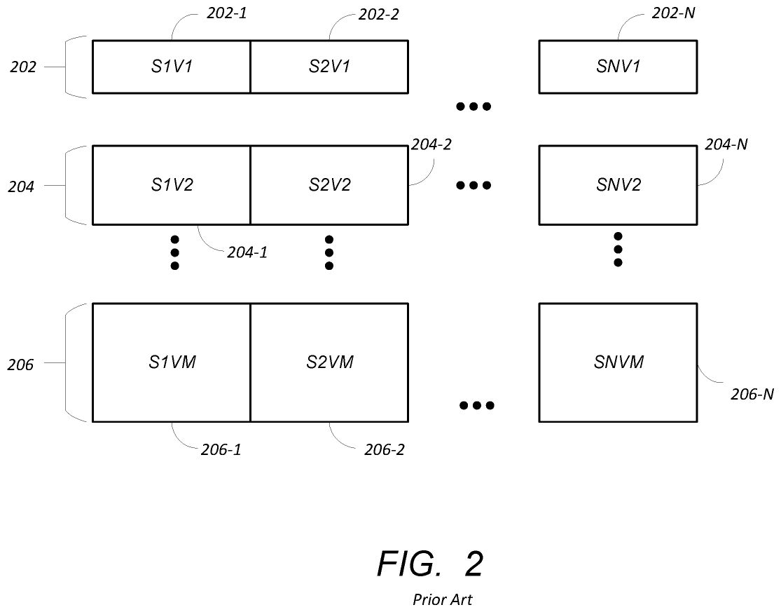

FIG. 2 is a diagram illustrating a representation of an HLS-encoded video program. In a typical HLS workflow, a video encoder that supports HLS receives a live video feed or distribution-ready media file. The encoder creates multiple versions (known as variants) of the audio/video at different bit rates, resolutions, and quality levels. In the embodiment illustrated in FIG. 2, M versions of the media program are created, with “V1” indicating a first (and “lightest”) version of the media program 202, “V2” indicating the second version of the media program 204 and “VM” indicating the M^{th} (and “heaviest” version of the media program 206.

The encoder then segments the variants 202-206 into a series of small files, called media segments or chunks. In the illustrated embodiment, the first version of the media program 202 is segmented into N segments S1, S2, . . . , SN of equivalent temporal length. The N segments of version one of the media program are denoted as S1V1 202-1, S2V1 202-2, . . . , SNV1 202-N, respectively, the N segments of version two of the media program are denoted as S1V2 204-1, S2V2 204-2, . . . , SNV2 204-N, respectively, and the N segments of version M of the media program are denoted as S1VM 206-1, S2VM 206-2, . . . , SNVM 206-N, respectively. In FIG. 2, the depicted size each chunk of each version of the media program is indicative of the size of the chunk in bytes. In other words, chunk S1VM 206-1 is a higher-resolution variant of segment S2 than is chunk S1V1 202-1.

At the same time, the encoder creates a media playlist file for each variant 202-206 containing a list of URLs pointing to the variant's media segments. The encoder also creates a master playlist containing a list of the URLs to variant media playlists, and descriptive tags to control the playback behavior of the stream. While producing playlists and segments, the encoder or automated scripts upload the files to a web server or CDN. Access is provided to the content by embedding a link to the master playlist file in a web page, or by creating a custom application that downloads the master playlist file.

In one embodiment, the encoder creates media segments by dividing the event data into short MPEG-2 transport stream files (.ts). Typically, the files contain H.264 video or AAC audio with a duration of 5 to 10 seconds each. The encoder typically allows the user to set the encoding and duration of the media segments, and creates the media playlists as text files saved in the M3U format (.m3u8). The media playlists contain uniform resource locators (URLs) to the media segments and other information needed for playback. The playlist type—live, event, or video on demand (VOD)—determines how the stream can be navigated.

A manifest is provided for the media program stream. The manifest comprises a master playlist and a media playlist. The master playlist provides an address for each of the individual media playlists in the media program stream. The master playlist also provides important properties of each available variant such as bandwidth, resolution, and codec. The MPP 108 uses that information to decide the most appropriate variant for the device and the currently measured, available bandwidth.

Hence, the master playlist (e.g. masterplaylist.m3u8) include variants of the media program, with each variant is described by a media playlist suitable for different communication channel throughputs. The media playlist includes a list of media segments or “chunks” to be streamed and reproduced, and the address where each chunk may be obtained.

In a specific example, the media playlists includes a media playlist cellular_video.m3u8, having a lower resolution version of the media program suitable for low bandwidth cellular communications channels, a wifi_video.m3u8 having a higher bandwidth version of the media program suitable for higher bandwidth communications channels, and appleTV_video.m3u8 having a high resolution version of the media program suitable for very high bandwidth communications channels). The order of the media playlists in the master playlist does not matter, except that when playback begins, the MPP 108 begins streaming first variant it is capable of playing, which is typically the lowest resolution variant of the media program 202. If conditions change and the MPP 108 can no longer play that version of the media program, the player switches midstream to another media playlist midstream of lower resolution. If conditions change and the MPP 108 is capable of playing a higher resolution version of the media program, the player switches midstream to the media playlist associated with that higher resolution version.

Referring back to FIG. 1, the receiver 102 104 transmits a media program request 114 to the MPP104, and in response, receives a master playlist 116. Using the master playlist, the MPP 108 selects a version of the media program (typically the version that is first on the master playlist, but may be the easiest version to decode, which is typically the smallest chunk or segment 206-1) and sends a media program version request 118 to obtain the media (segment) playlist 120 associated with that version of the media program. The MPP 108 receives the media playlist 120, and using the media playlist 120, transmits segment requests 122 for the desired media program segments. The media server 110M retrieves the media program segments 124 and provides them to the MPP 108, where they are received, decoded, and rendered.

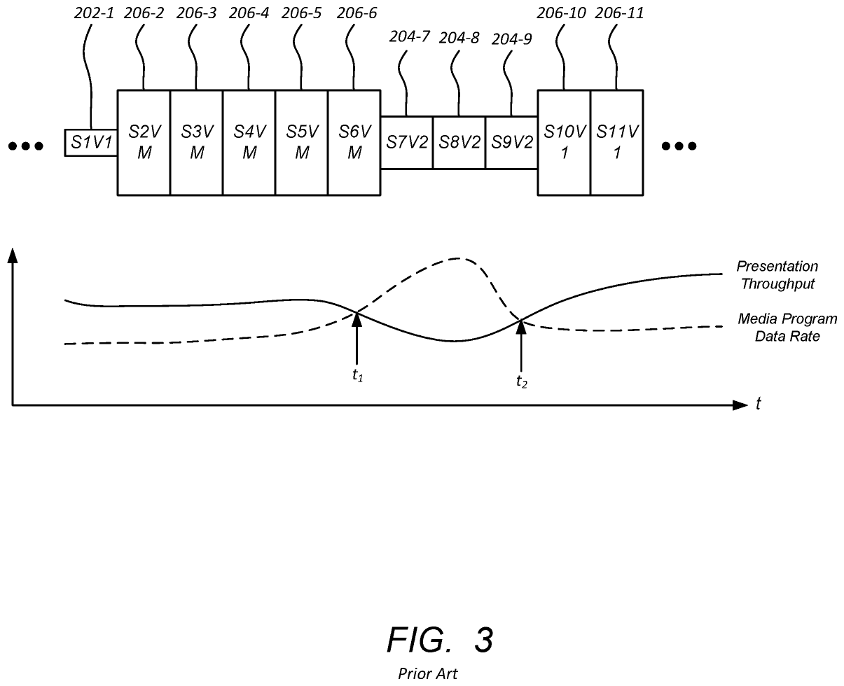

FIG. 3 is a diagram illustrating one example of the streaming of segments of a media program using the HLS protocol. Modern video compression schemes such as MPEG result in frames or series of frames having more data than other frames or series of frames. For example, a scene of a media program may depict a person or object against a smooth (spatially substantially unchanging) and/or constant (temporally substantially unchanging) background. This may happen, for example if the scene is comprised of a person speaking. Such scenes typically require less data than other scenes, as the MPEG compression schemes can substantially compress the background using spatial and temporal compression techniques. Other scenes may depict a spatially and temporally complex scene (for example, a crowd in a football stadium) that cannot be as substantially compressed. Consequently, the size of the data that needs to be communicated to the MPP 108 and decoded and rendered by the MPP 108 varies substantially over time, as shown in FIG. 3. At the same time, the presentation throughput (the throughput of the communication channel combined with the computational throughput of the MPP 108 in decoding and rendering the media program) also changes over time. Since more complex frames may require more processing to decode and render, the processing throughput of the MPP 108 can be inversely related to the media program data rate, with processing throughput (and hence, the presentation throughput) becoming lower when the media program data rate is highest.

To account for this, the MPP 108 refers to the master playlist to find a media playlist of segments more suitable for the presentation throughput, retrieves this media playlist, and using the media playlist, requests segments of the appropriate type and size or the presentation throughput and the media program data rate. In the example presented in FIG. 3, the MPP 108 has requested media program segments 202-1 through 202-6 from a first media playlist. Media program segment 202-1 S1V1 is selected, as it is the smallest and easiest to process segment. The decoder 126 thereafter determines that it can process and decode segments of higher bit rate and resolution, so thereafter requests and receives higher resolution and higher bit rate media program segments 206-2 through 206-6 which are decoded, and rendered with no degradation of quality, as the media program data rate remains less than the presentation throughput. However, at time t1, the media program data rate (or resolution) rises and the presentation throughput falls to the point where the quality of playback is no longer as desired. At this point, the MPP 108 detects the inadequate presentation throughput and consults the master playlist to find a media playlist for a “lighter” (e.g. smaller in size and/or easier to perform the presentation processing) version of the media program. The MPP 108 uses the master playlist 116 to transmit a media program version request 118′ for a media segment playlist 120′ of media program segments of that can be received and presented with adequate quality. In the illustrated embodiment, this is version 2 of the media program. The MPP 108 receives this media playlist 120′ and uses the playlist to select the required media program segments. Since segments 1-6 have already been provided, the MPP 108 transmits a segment request 122 for media program segments of version two of the media program beginning with segment seven, S7V2 204-7. The MPP 108 continues to request version two of the media program, so long as the media program data rate exceeds the available presentation throughput. Similarly, at time t2, the MPP 108 detects that the available presentation throughput exceeds the media program data rate, and using analogous procedures to those described above, requests segments 10 and 11 of the first version of the media program.

### Virtual Headend System Using ABR Transmission

The foregoing illustrates a system where a receiver 102 is used to receive and decode media programs from the media program provider 104 using the HLS protocol. There exist devices that receive media programs via the HLS protocol, but once received, the media programs must be converted to be compatible for reception by devices designed to receive and process traditional transport streams. Such devices operate much like the receiver 102 described above, but process the media segments to assemble them into a transport stream. This can be accomplished by decoding the HLS segments into a decompressed series of video frames, then re-encoding them into a transport stream that the end device is designed to accept and process. While this solution may resolve any time base ambiguities and errors, this solution is processing intensive, time consuming, and introduces video quality loss. Instead, it is advantageous to convert the frames received in the HLS protocol to frames presented in a transport stream. In this instance, the receiver 102 still receives the segments as described in FIG. 1, but does not decode or render them, and does not provide them to display 125. Instead, they are processed to place the media content received in the HLS protocol to a transport stream. Such a device can be thought of as a virtual headend system.

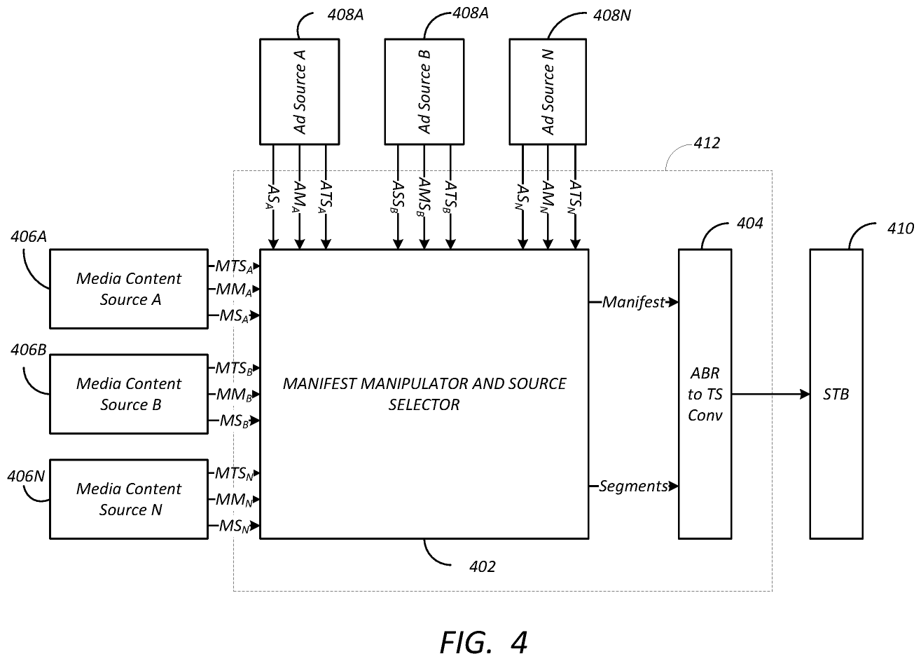

FIG. 4 is a diagram of a virtual headend system (VHS) 412 for transmitting media content manifested in transport streams (such as those complying with the MPEG standard) via an adaptive bit rate media delivery protocol such as HLS or DASH. The system bridges the gap between expectations of the decoder of the STB 410 (designed to accept an MPEG compliant transport stream (TS) or similar) and the reality of clock changes, drift, and other inaccuracies introduced when the TS is converted to ABR for transmission, and reconverted to a TS stream.

The VHS 412 accepts one or more media content transport streams MTS_{A}-MTS_{N} (herein referred to alternatively as media content transport stream(s) MTS) from one or more media content sources 406A-406N (hereinafter referred to as media content source(s) 406) and alternative content transport streams such as advertising content transport streams ATS_{A}-ATS_{N} (alternatively referred to hereinafter as advertising content transport streams ATS) from one or more advertising content sources(s) 408A-408N. The manifest manipulator and source selector (MMSS) 402 selects which media content transport stream MTS and advertising content stream ATS is to be transmitted to the STB 410. Typically, ATSs are inserted at advertising breaks that are defined in the selected media program and provided to the MMSS 402, but the MMSS may alternatively determine such advertising breaks. The MMSS 402 then converts the selected MTS and ATS to an ABR-compliant delivery protocol comprising one or more manifests and segments. A communicatively coupled ABR to TS converter (ATC) 404 converts the ABR information back to a MPEG compliant transport stream comprising the selected MTS and ATS and provides it to the STB 410.

The VHS 412 may also accept media content transmitted using an ABR-compliant delivery protocol rather than a transport stream. In this instance, the MMSS 402 uses the manifests and segments delivered from the media content sources 406 (MM_{A}-MM_{N} and MS_{A}-MS_{N}, respectively) and the advertising content sources 408 (AM_{A}-AM_{N} and AS_{A}-AS_{N}, respectively), selects segments for presentation, and modifies the received manifests as required to allow the selected segments to be presented to generate new manifest(s).

The VHS 412 is an ABR client (receiving ABR manifests and chunks like receiver 102) but unlike a traditional client, the VHS 412 does not decode media segments and stitch the results for presentation. Instead the VHS 412 must efficiently (i.e. without transcoding) construct a TS stream such that it can be delivered to legacy S′1B 410 without violating buffer/timing constraints.

ABR content presents two problems for the VHS 412 as a client. First, mismatches between the meta data provided in the manifest and the actual content can lead to large buffer underflows or timing problems in the decoder. The handling of these errors is undefined, so it would be desirable for the VHS 412 to correct them in such a way that behavior is well defined and less visible.

Second, legacy downstream devices such as STBs 410 will lock to the clock produced by the VHS 412 in the ABR to TS conversion process. Likewise, the ATC 404 wants to lock to the clock of the ABR source 406/408 but the ATC 404 does not have a continuous stream of data delivered with a high precision time stamp to perform this locking. The ATC 404 can lock to the clock provided by the ABR sources 406/408, by estimating drift over a long time period, but once there is enough data to estimate the drift rate, the constraints of ISO 13818-1 (hereby incorporated by reference herein) limits the amount of correction that can be applied without violating the specification. The limited correction rate may make buffering over/under runs unavoidable in the ATC 404 which leads to undefined glitches in the decoder. Therefore, there is a desire for the VHS 412 to make an adjustment to avoid under/over runs.

### Overview

The foregoing issues are similar to those faced in the transition from tape based analog video to digital video. The analog sources had unreliable timing and a time base corrector (TBC) was required to provide clean output timing from noisy inputs by inserting or deleting single frames. A traditional PC-based ABR client operates like a TBC by adding and deleting individual audio/video frames subject to the presentation clock.

For the VHS 412, the IBC challenge is to reconcile the meta data based ABR clock against the internally maintained clock seen by downstream decoders in the STBs 410. This internally maintained clock is entirely under the control of the VHS 412, but is subject to the timing and buffering constraints dictated by ISO 13818-1. The internally maintained VHS clock and the STB clock can drift apart because of mismatches between the meta data and the actual content, or because of long term drift between the VHS's clock and the clock used by the clock of the media content or advertising sources 406/408.

In the description below, the ATC 404 of the VHS 412 resolves timing issues by adding or deleting audio/video frames to the segments at the end of advertisement (ad) transitions . Unlike traditional TBC, these operations occur in the compressed domain. That is, the data itself is not decompressed, time base corrected, and recompressed.

Ad transitions give a natural point to make these adjustments as the content is expected to change rapidly which masks any modifications made to the video or audio data itself. Also, ad transitions are known to be random access points in the data stream such as instantaneous decoding refresh (IDR) points, which are analogous to I-frames in the MPEG standard. IDR access units are at the beginning of a coded video sequence, and contain an intra picture which is a coded picture that can be decoded without decoding any previous pictures in the unit stream. The presence of an IDR access unit indicates that no subsequent picture in the stream will require reference to pictures prior to the intra picture it contains in order to be decoded. Thus, such frames can be decoded independently of any other coded video sequence or frame, given the necessary parameter set information.

In cases where there is a gap in media or advertising content, the ATC 404 can insert black video/silent audio to fill the gap and reduce timing errors. For a gap introduced by drift scenario, the timing can be corrected typically by a small number of frames (1-3), but for a mismatch the gap could be many frames. Such mismatches can occur when the metadata describing the stream is in error. For example, the metadata could indicate that a segment is 1.2 seconds, but due to errors, the segment itself may be only 1.0 seconds.

In one implementation, the silent audio frames are constructed based on the audio codec within the spliced advertisement (as defined by the associated metadata) while the video frames are optionally precomputed black frames of the same resolution and format of the video codec within the spliced advertisement. These video frames are constructed in the compressed domain but since the ad splice boundary is known to be a random access point IDR frames, such frames can be inserted safely, even in the compressed domain. Furthermore, since the content of the video is black, the frames can be constructed apriori based on the known resolution of the media content or quickly on the fly for arbitrary resolutions. In any case, the video component for a single frame would comprise a handful of packets so that it could easily be delivered without breaking buffer models. For example, when scheduling to send a frame to the decoder, three constraints must be met. First, the frame must not be sent too early. This can be assured by requiring that the time difference between the decoding time stamp (DTS) and the program clock reference (PCR) is less than a certain value of time (e.g. DTS-PCR <N seconds.) Second, the frame cannot be sent to late. This can be assured by requiring that the difference between the DTS and the PCR is greater than zero, or DTS-PCR >0. A final requirement is the frames should not be provided to the decoder in a manner that causes the buffer to overflow. In cases where the frame is only a handful of packets, it is more likely possible to insert the frame into the stream while meeting requirements above and not impacting delivery of subsequent frames. A large frame (e.g. a complex I-frame) may not be deliverable within constraints or it may make future frames under-deliverable within constraints.

A natural extension of this idea if lookahead is available is to replicate the first IDR in the next segment to fill any gap. In the case where such lookahead is available, this gap filling technique can be used at any segment boundary to avoid generating buffering underflows in downstream devices. In both cases, the downstream decoder of the STB is presented with a continuous sequence of audio/video conforming to the buffer models and ISO 13818-1 timing constraints.

In case where there is too much media content to deliver, audio/video frames are dropped. Audio frames can be dropped at will, as each frame can be independently decoded. The exact rules for dropping video frames depends on the codec and the coding structure. In most coding structures, dropping a single video frame in the compressed domain is difficult due to the difference between coding order and presentation order (video frames are typically coded and decoded in different order than they are presented, as some frames are bidirectionally predictive, and need both preceding and following frames to be decoded first). While theoretically problematic in a completely general case, in most realistic encoder configurations, there is a relatively small set of frames that can be safely dropped. In this case, if the ATC 404 needs to drop N frames , it needs to drop a greater number of frames (to account for frame interdependencies between anchor, predictive, and bi-predictive frames), then reinsert the number of frames so that the net effect is N fewer frames. For example, if it is desired to drop N frames, M frames (where M>=N) need to be dropped, then M-N frames must be inserted. While it is possible to construct a stream where the number of frames required to be dropped would be unrealistically large, this scenario is unlikely to occur in practice.

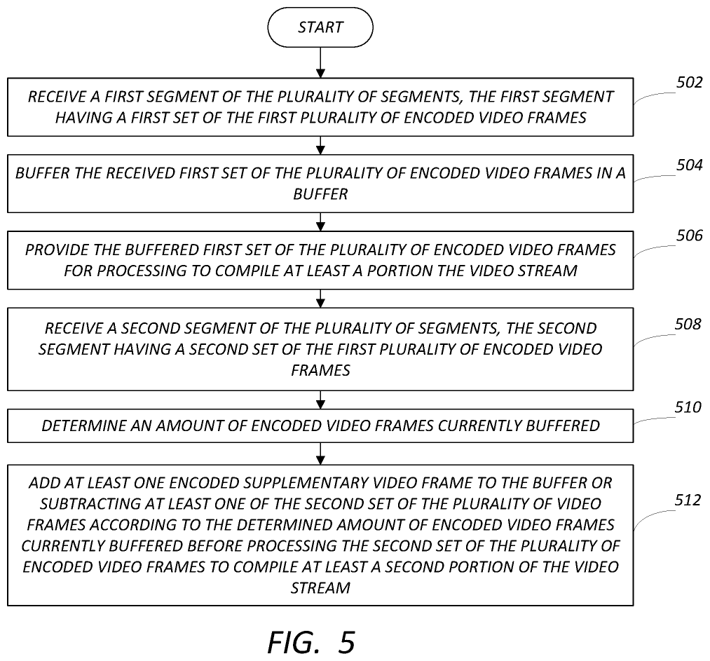

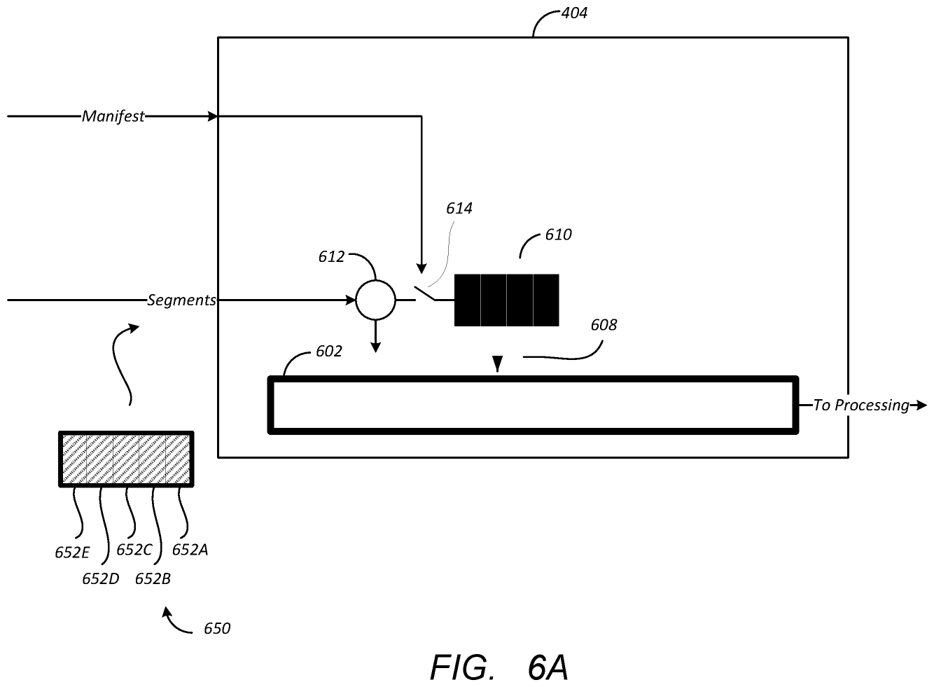

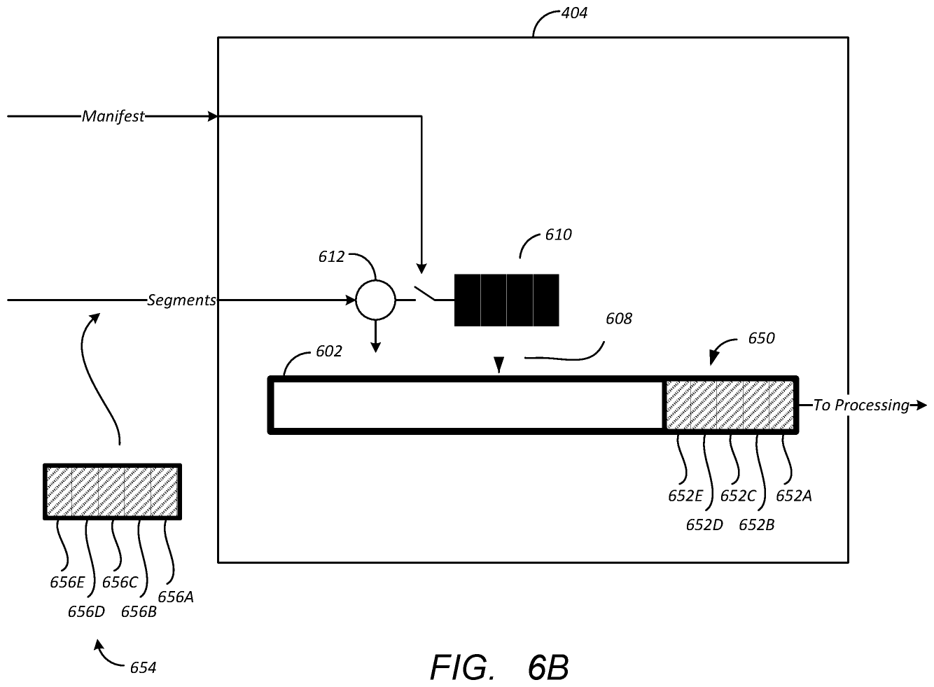

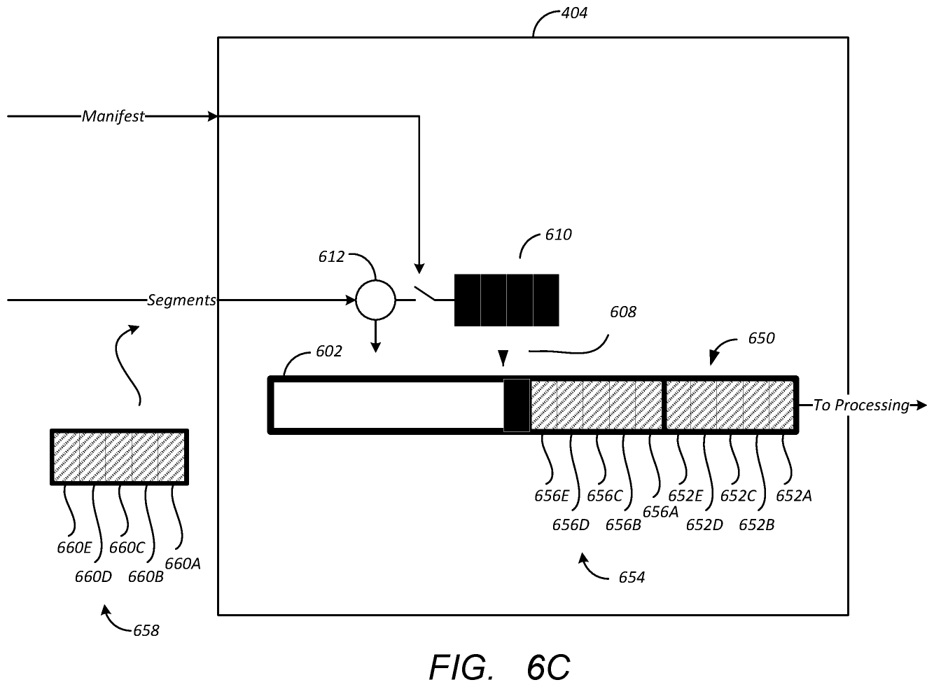

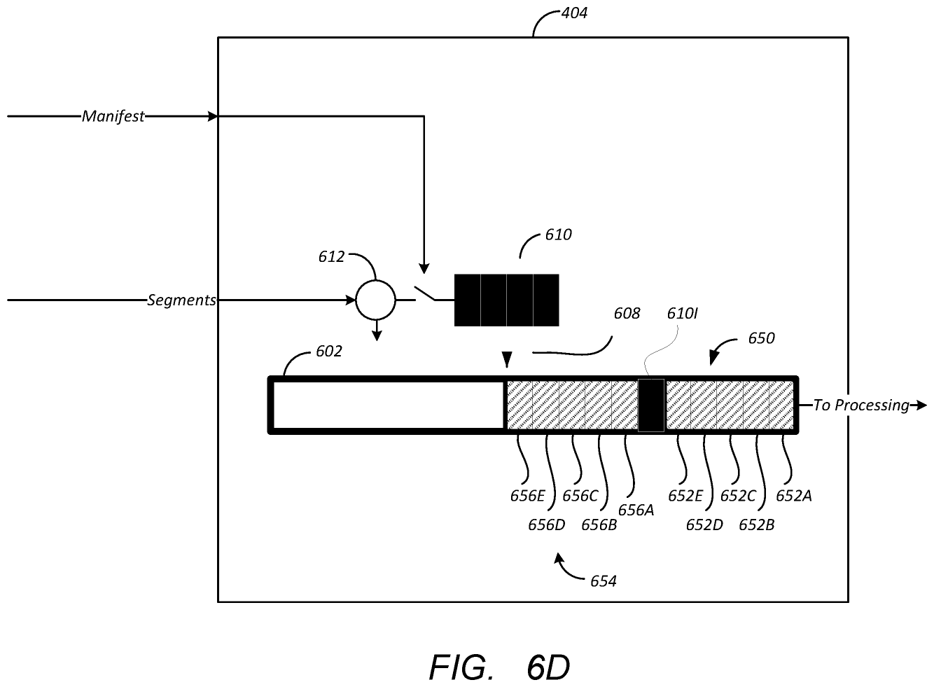

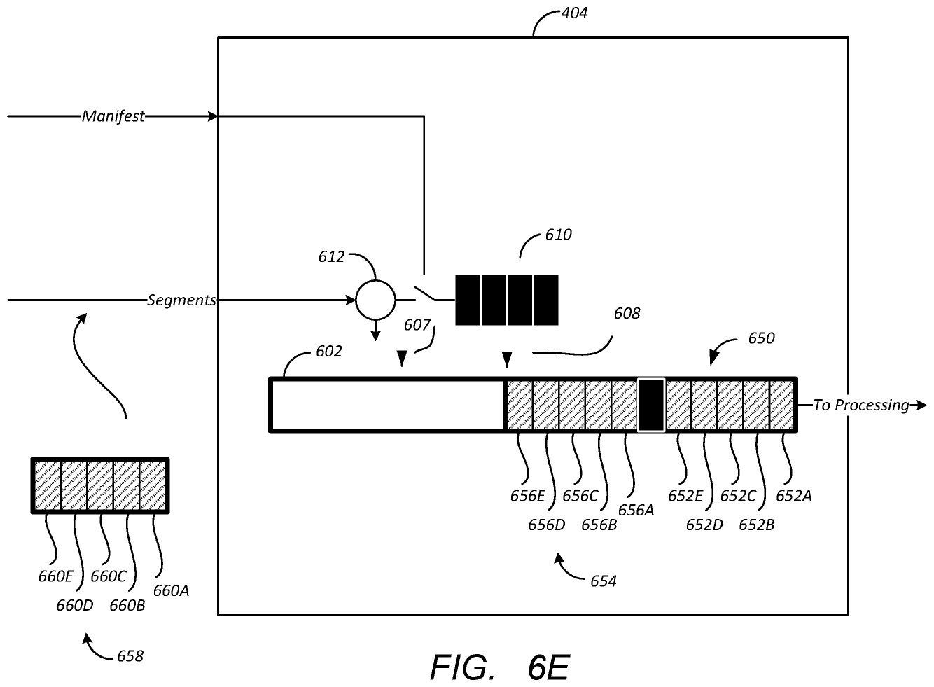

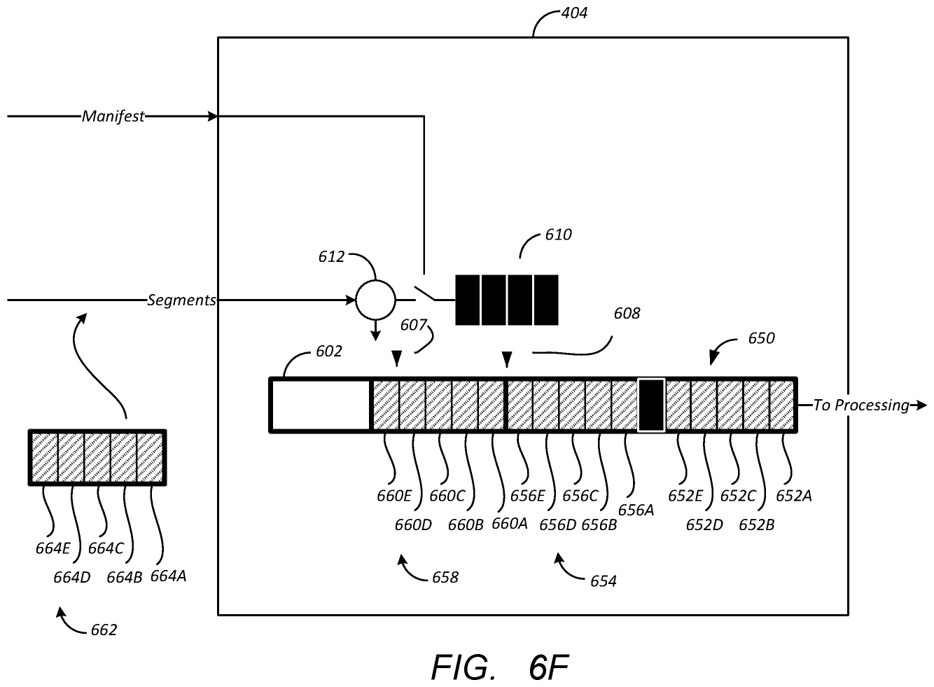

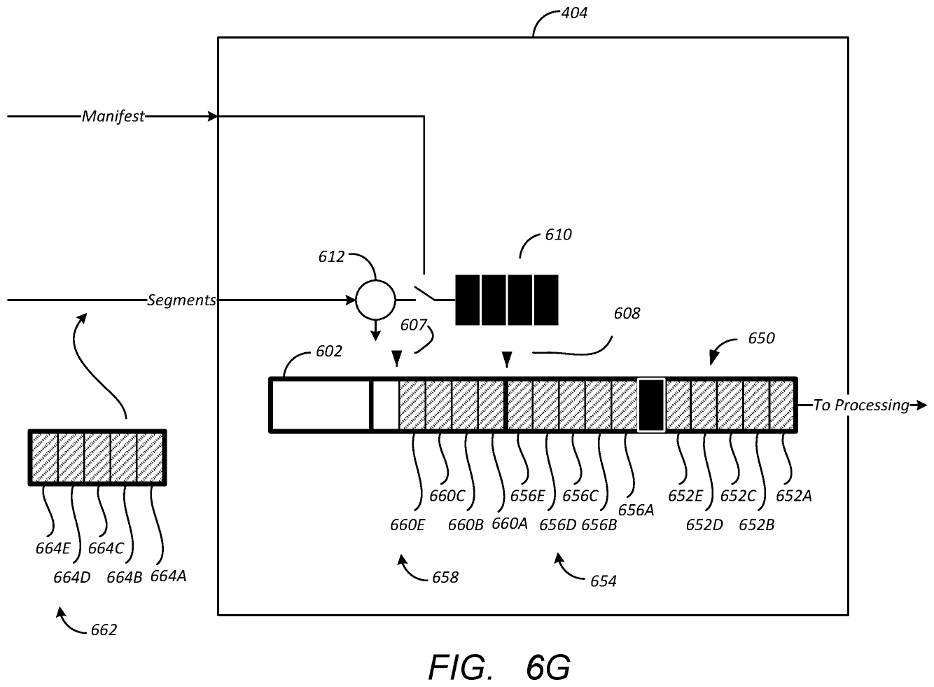

FIG. 5 is a diagram illustrating one embodiment of a method for correcting a time base of an audio/video stream. FIG. 5 will be discussed in conjunction with FIGS. 6A-6F, which present a diagram of an ATC 404 inserting and deleting encoded video frames to account for timing discrepancies.

Referring first to FIG. 6, the ATC 404 comprises a buffer 602 for buffering video segments and frames before providing the video segments 650, 654, 658 and frames 652 for processing by the decoder in the STB 410. The buffer 602 has the capacity to store a limited number of segments 650 and frames 652. The exact number of frames that can be stored is difficult to predict, because the frames can vary considerably in size but the total time a frame can reside in the buffer is bounded and this implies a maximum number of frames

The manifest determines which of the segments 650 are placed in the buffer 602 for presentation, and also indicates when the segments end and begin. Logical switch 614 inserts supplementary encoded video frames 610 into the buffer 602 via adder 612 under the circumstances and as described below to perform audio visual time base corrections as needed. The illustrated supplementary encoded video frames 610 are black frames and are computed in advance to simplify processing, but other embodiments in which frames have image content derived from segment frames and are computed on the fly before insertion are also described.

The fullness of the buffer 602 (determined from a comparison of the buffer capacity and the total size of the frames 652 stored therein at any particular time) is compared to a buffer threshold fullness 608 to determine when supplementary encoded video frames 610 are inserted into the buffer 602, as well as how many should be inserted.

Turning now to FIG. 5, a manifest (selected from the plurality of manifests by the MMSS 402) is received by the ATC 404. In block 502, a first segment 650 of a plurality of segments is received. Like the other segments that are received, the first segment 650 has a plurality of encoded video frames 652A-652E. The segment of data is examined for pertinent metadata such as the frame rate and resolution. Next, the frames that are to be played out of the VHS 412 are scheduled and time stamps are associated with each MPEG packet. These time stamps are generated by the VHS 412, and correspond to the VHS's version of the PCR clock. In block 504, the received first set of encoded video frames 652 are buffered (e.g. provided to and stored in buffer 602). In block 506, the buffered first set of the plurality of encoded video frames are provided for processing to decode the encoded video frames, and compile them into the video stream.

The result is shown in FIG. 6B. Frames 652 have been stored in the buffer 602 and are being provided to the decoder for processing to decode the encoded video frames 652. The decoded video frames are provided for presentation, for example, in a transport stream.

Referring now to FIG. 6B, a second segment 654 is received, as shown in block 508 of FIG. 5. The second segment 654 includes a second set of the first plurality of video frames 656A-656E. In block 510, the amount of storage capacity of the buffer 602 (or number of encoded frames that are currently buffered) is determined.

Finally, in block 512, at least one encoded supplementary video frame is added to the buffer 602 or at least one of the second set of the plurality of video frames is subtracted according to the determined amount of encoded video frames currently buffered (e.g. the fullness of the buffer 602).

In one embodiment, this is accomplished by, each time a segment is received: examining the depth of the buffer 602 (how much data has been buffered to be provided for decoding), determining whether the buffer depth is increasing or decreasing, and adding supplementary video frames or subtracting existing video frames based on the buffer depth. Further, the presentation time stamp of each supplementary video frame is selected and the presentation time stamp of each video frame subsequent to the inserted supplementary video frame is adjusted so that they account for the inserted supplementary encoded video frame 610. This process is repeated for each successive segment of video frames received by the ATC 404.

Note that timing irregularities are not determined by comparison of the duration of the segment as described in the manifest and the duration of the frames that are stored in the buffer 602, being scheduled to be decoded and played. Rather, buffer depth is used as a proxy for such timing discrepancies. Using buffer depth as a measure rather than simply determining timing differences by examination of the manifest time and the actual segment time has the advantage of accounting for both timing differences and clock drift. This is important because although the MPEG transport stream standard permits clock frequency to be changed, it limits how quickly the clock speed can be changed. Further, although splicing frames into an MPEG stream requires knowing when such frame can be inserted without disturbing the decoding, the insertion of video frames at segment boundaries is not problematic, as segment boundaries to not cross NAL units or groups of pictures.

In one embodiment, this is accomplished by comparing the amount of encoded video frames currently buffered to the threshold buffer fullness 608. If the amount of encoded video frames currently buffered is less than the threshold buffer fullness 608, one or more supplementary encoded video frames 610 can be added to the buffer. This is illustrated in FIG. 6C. Video frames 656 were added to the buffer (in a FIFO arrangement) to be presented for processing after video frames 652. The size and number of the video frames are insufficient to bring the buffer 602 fullness up to the threshold buffer fullness value 608, so one supplementary encoded video frame 610 is added to the buffer 602 as well. Audio frames are handled similarly, with a silent supplementary audio frame (which may also be precomputed) inserted into the buffer 602 for processing.

In the illustrated embodiment, the supplementary encoded video frame 610 is appended to the end of the second segment 654, after the last encoded video frame 656E in the segment 654. Other implementations are possible, for example, in which the supplementary encoded video frame 610 is inserted between the first segment 650 and the second segment 654. With the supplementary encoded video frame 610 inserted, the buffer fullness is at the threshold buffer fullness 608.

Referring back to FIG. 6B, the buffer 602 is not close to capacity after the insertion of frames 652, and hence, a significant number of supplementary encoded video frames 610 would have been necessary to be added to the buffer 602 in order to bring the buffer fullness up to the desired threshold buffer fullness 608. This would have had the advantage in quickly bringing the buffer fullness to the threshold buffer fullness 608 value, but the insertion of a large number of supplementary encoded video frames 610 may result in a noticeable gap in the presentation of the video stream. Accordingly, rules can be employed regarding the number and/or frequency of insertion of supplementary encoded video frames in order to eliminate such gaps. One such rule is to forego inserting such supplementary encoded video frames 610 until such time that the buffer fullness exceeds the threshold buffer fullness 608 or is close enough to exceed the threshold buffer fullness 608 with a small number (one or two are typically sufficient) of supplementary encoded video frames 610, and implementing the insertion of supplementary encoded video frames 610 from that point in time forward (as is illustrated in FIG. 6C).

Another such rule is to limit the number of frames inserted in each instance to a particular number of frames. FIG. 6D is a diagram illustrating the application of this rule. As illustrated, the ATC 404 inserted one supplementary encoded video frame 6101. This is insufficient to bring the buffer fullness to the threshold buffer fullness value 608, but will permit meeting that threshold with the insertion of the next segment 654 of encoded video frames 656, also as illustrated in FIG. 6D. If this was insufficient to bring the buffer fullness to the threshold buffer fullness value 608, another supplementary encoded video frame 610 can be inserted after the last frame 656E of the second segment 654. FIG. 6D also illustrates that the encoded supplementary encoded video frame 610 can be inserted either between segment 654 and segment 650, or can be added to the end of segment 650 (after encoded video frame 652E) or to the end of segment 654 (before encoded video frame 656A). The insertion of encoded video frames involves splicing the encoded video frame to other frames.

For example, consider splicing a black frame between two segments. In this example, the frame rate is 29.97, so the time between DTS values is 3003. Without the splice we have the relationships shown in Table I below.

TABLE I

| DTS | PCR Delta | Type |
|---|---|---|
| 0 | 15000 | Primary Media Content |
| 3003 | 12000 | Primary Media Content |
| 6006 | 9000 | Advertisement |
| 9009 | 6000 | Advertisement |

PCR Delta represents the difference between the DTS and the PCR , which represents the length of time a frame resides in the decoder buffer prior to decoding. Note the time between decode and the current PCR is continually shrinking in the example. When a new frame is spliced in between the primary media content and the advertisement, the result is shown in Table II.

TABLE II

| DTS | PCR Delta | Type |
|---|---|---|
| 0 | 15000 | Primary Media Content |
| 3003 | 12000 | Primary Media Content |
| 6006 | ~9000 | Inserted Frame |
| 9009 | ~12003 | Advertisement |
| 12012 | ~9003 | Advertisement |

In the foregoing, it is assumed the inserted frame is very small so it takes only a couple packets to transmit—which is approximate to zero. Put another way, the transmission time for the frame is much less than the allotted frame duration. The net impact is that the PCR delta increases, providing more flexibility in delivering subsequent frames.

The foregoing embodiment envisions adding one or more supplementary encoded video frames 610 to the buffer 602 in order to keep the buffer fullness near the threshold buffer fullness 608. This solution is advantageous because adding encoded frames (particularly black frames to the end or beginning of a segment) is a relatively simple matter. Although more difficult, time base adjustments may also be implemented by subtracting video frames when the buffer fullness exceeds a threshold. That threshold may be a different threshold than the threshold buffer fullness 608 used to determine when supplementary encoded video frames 610 should be added.

FIG. 6F is a diagram illustrating an embodiment where one or more video frames are extracted when the buffer fullness exceeds a second threshold 607. As shown in FIG. 6E, new segment 662 has been provided with frames 664A-664E and segments 650 and 654 have been added to the buffer, but none have been processed and remain in the buffer 602. When a third segment 658 having encoded video frames 660A-660E is supplied for buffering, the addition of the third segment 658 to the buffer 602 results in the buffer fullness exceeding the second threshold 607. To resolve this issue, one of more of the video frames 660A-660E can be removed from the segment 662 before the remaining frames are provided to the buffer. The result is shown in FIG. 6G, where encoded video frame 660D was removed before storing the remaining encoded video frames in the buffer 602.

The segments presented to the decoder include segments with primary media content (e.g. the media program desired to be viewed), and segments with advertisements. Advertisements include entirely different content than the primary media content, and in such cases, the insertion of a small number of black encoded video frames or other supplementary encoded video frames will not substantially degrade the viewing experience (as there is typically some black interval between the primary media content and the advertisement). Similarly, the removal of video frames during transitions from primary media content to advertisements should minimize the disruption of the viewing experience. Accordingly, in one embodiment, the ATC 404 determines, using information in the manifest, that the incoming segment of video frames comprises at least a portion of an advertisement, and only inserts (or deletes) frames if it detects a transition from primary media content to the advertisement or the advertisement to the primary media content.

Compressed video content typically comprises what are known as I-frames, B-frames, and P-frames, arranged in a group of pictures (GOP). I-frames are intra-coded frames that represent a complete image and can be decoded without reference to any other frames, as they do not use frame-to-frame compression techniques. P-frames are predicted pictures, and include only changes in the image from the previous frame. Hence, a complete image cannot be obtained from the P-frame alone. B-frames are bi-directional predicted pictures, and require information from both a previous frame and a subsequent frame to be decoded. As I-frames include all of the information necessary for decoding, they are also much larger in size than P-frames or B-frames, but they are more easily insertable between GOPs without difficulty. Further, a black encoded video I-frame has less information than a typical I-frame, and can be transmitted in a short amount of time. Therefore, in embodiments where a small number of supplementary encoded video frames are to be inserted, those frames may be precomputed I frames with only black video content. Likewise, IDR frames (instantaneous decoder refresh) can be used. IDR frames are a special type of I-frame used in some decoding protocols (H.264, for example) are require that no frame after the IDR frame can reference any frame before it, thus easing trick play and seeking requirements.

Although the insertion of black supplementary encoded frames is computationally and logistically advantageous, it is possible to insert frames with media content. For example, referring to FIG. 2C, rather than insert an black supplementary encoded video frame as illustrated, the ATC 404 may replicate the first IDR frame (e.g. the first frame of the next segment 658) and insert that replicated frame for the supplementary encoded video frame. The resulting frame will generally be relatively large in size, but would, in some circumstances, be less obtrusive than the insertion of a black frame.

### Hardware Environment

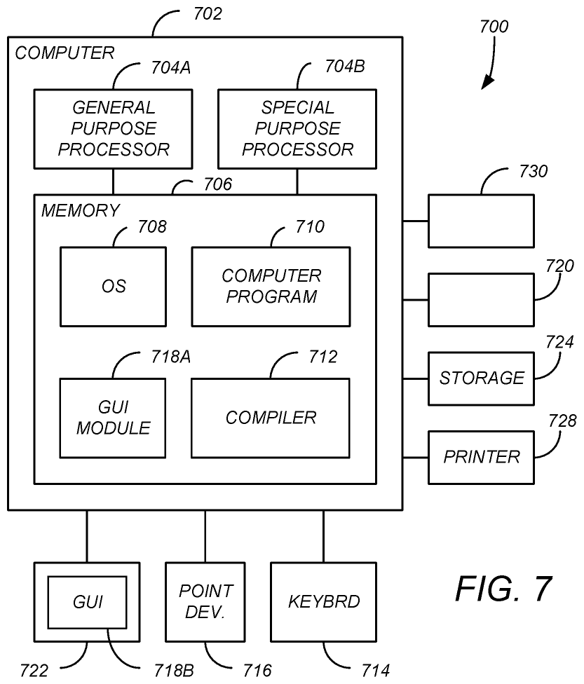

FIG. 7 illustrates an exemplary computer system 700 that could be used to implement processing elements of the above disclosure, including the media program provider 104, the receiver 102, the display 125, VHS 412 and the STB 410. The computer 702 comprises a processor 704 and a memory, such as random access memory (RAM) 706. The computer 702 is operatively coupled to a display 722, which presents images such as windows to the user on a graphical user interface 718B. The computer 702 may be coupled to other devices, such as a keyboard 714, a mouse device 716, a printer 728, etc. Of course, those skilled in the art will recognize that any combination of the above components, or any number of different components, peripherals, and other devices, may be used with the computer 702.

Generally, the computer 702 operates under control of an operating system 708 stored in the memory 706, and interfaces with the user to accept inputs and commands and to present results through a graphical user interface (GUI) module 718A. Although the GUI module 718B is depicted as a separate module, the instructions performing the GUI functions can be resident or distributed in the operating system 708, the computer program 710, or implemented with special purpose memory and processors. The computer 702 also implements a compiler 712 which allows an application program 710 written in a programming language such as COBOL, C++, FORTRAN, or other language to be translated into processor 704 readable code. After completion, the application 710 accesses and manipulates data stored in the memory 706 of the computer 702 using the relationships and logic that was generated using the compiler 712. The computer 702 also optionally comprises an external communication device such as a modem, satellite link, Ethernet card, or other device for communicating with other computers.

In one embodiment, instructions implementing the operating system 708, the computer program 710, and the compiler 712 are tangibly embodied in a computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of instructions which, when read and executed by the computer 702, causes the computer 702 to perform the operations herein described. Computer program 710 and/or operating instructions may also be tangibly embodied in memory 706 and/or data communications devices 730, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure. The foregoing discloses an apparatus, method and system for correcting a time base of a video stream, the video stream compiled from video data received in a plurality of segments having a plurality of video frames encoded according to an adaptive bit rate protocol. The method includes: (a)receiving a first segment of the plurality of segments, the first segment having a first set of the first plurality of encoded video frames; (b)buffering the received first set of the plurality of encoded video frames in a buffer; (c)providing the buffered first set of the plurality of encoded video frames for processing to compile at least a portion the video stream; (d)receiving a second segment of the plurality of segments, the second segment having a second set of the first plurality of encoded video frames; (e)determining an amount of encoded video frames currently buffered; and (f)adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered before processing the second set of the plurality of encoded video frames to compile at least a second portion of the video stream.

Implementations may include one or more of the following features:

The method described above, wherein The method further including: determining that the second segment of the plurality of segments includes at least a portion of an advertisement; and wherein step (f) is performed only if the second segment of the plurality of segments includes at least a portion of the advertisement.

Any of the above methods, wherein adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered includes: comparing the amount of encoded video frames currently buffered to a first threshold; and adding the at least one video frame if the amount of encoded video frames currently buffered is below a first threshold.

Any of the above methods, wherein the least one video frame is added to the second set of the plurality of encoded video frames.

Any of the above methods, wherein the at least one video frame is added to an end of the second segment.

Any of the above methods, wherein adding at least one encoded supplementary video frame to the end of the second segment includes: splicing the at least one supplementary video frame to the second set of the plurality of encoded video frames.

Any of the above methods, wherein each of the plurality of encoded video frames of the video stream includes a time stamp, and the method further includes determining a time stamp of the each of the at least one supplementary encoded video frames, and adjusting the time stamp of each of the encoded video frames subsequent to the supplementary encoded video frames.

Any of the above methods, wherein the at least one video frame is added to a beginning of the second segment.

Any of the above methods, wherein the at least one video frame is added to a beginning of a subsequently received third set of the plurality of encoded video frames received in a third segment of the plurality of segments.

Any of the above methods, wherein the at least one supplementary video frame is a precomputed black frame.

Any of the above methods, wherein the at least one supplementary video frame is an IDR frame replicated from a first IDR frame of a subsequently received third set of the plurality of encoded video frames received in a third segment of the plurality of segments.

Any of the above methods, wherein the plurality of segments include a plurality of audio frames and a supplementary audio frame for every at least one supplementary video frame.

Any of the above methods, wherein adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered includes: comparing the amount of encoded video frames currently buffered to a second threshold; and subtracting at least one of the second set of the plurality of video frames if the amount of encoded video frames currently buffered is above a second threshold.

Another embodiment is evidenced by a an apparatus for correcting a time base of a video stream, the video stream compiled from video data received in a plurality of segments having a plurality of video frames encoded according to an adaptive bit rate protocol. The apparatus includes a processor; a memory, communicatively coupled to the processor, the memory storing processor instructions including processor instructions for performing any of the operations described in the foregoing method steps.

For the case of mismatches between the ABR timing meta data and the audio/video content, the benefits of this technique are relatively clear in controlling downstream decoder behavior. Longer term drift issues, which arise because the process of estimating VHS clock frequency relative to the input clock requires a long time for ABR inputs. By the time the 400 determines the frequency discrepancy, there is a good chance that insufficient time remains to avoid an over/under flow as the VHS 412 attempts to skew its frequency to match the source frequency while simultaneously keeping the skew rate in compliance with ISO 13818-1. However, insertion/deletion of frames in the compressed domain helps prevent under/over runs while the VHS 412 clock slowly locks to the source clock.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of correcting a time base of a video stream, the video stream compiled from video data received in a plurality of segments having a plurality of video frames encoded according to an adaptive bit rate protocol, comprising:
(a) receiving a first segment of the plurality of segments, the first segment having a first set of the first plurality of encoded video frames;
(b) buffering the received first set of the plurality of encoded video frames in a buffer;
(c) providing the buffered first set of the plurality of encoded video frames for processing to compile at least a portion of the video stream;
(d) receiving a second segment of the plurality of segments, the second segment having a second set of the first plurality of encoded video frames;
(e) determining an amount of encoded video frames currently buffered; and
(f) adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered before processing the second set of the plurality of encoded video frames to compile at least a second portion of the video stream.

2. The method of claim 1, further comprising:
determining that the second segment of the plurality of segments comprises at least a portion of an advertisement; and
wherein step (f) is performed only if the second segment of the plurality of segments comprises at least a portion of the advertisement.

3. The method of claim 1, wherein adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered comprises:
comparing the amount of encoded video frames currently buffered to a first threshold; and
adding the at least one video frame if the amount of encoded video frames currently buffered is below a first threshold.

4. The method of claim 3, wherein the least one video frame is added to the second set of the plurality of encoded video frames.

5. The method of claim 4, wherein the at least one video frame is added to an end of the second segment.

6. The method of claim 5, wherein adding at least one encoded supplementary video frame to the end of the second segment comprises:
splicing the at least one supplementary video frame to the second set of the plurality of encoded video frames.

7. The method of claim 6, wherein each of the plurality of encoded video frames of the video stream comprises a time stamp, and the method further comprises determining a time stamp of the each of the at least one supplementary encoded video frames, and adjusting the time stamp of each of the encoded video frames subsequent to the supplementary encoded video frames.

8. The method of claim 4, wherein the at least one video frame is added to a beginning of the second segment.

9. The method of claim 3, wherein the at least one video frame is added to a beginning of a subsequently received third set of the plurality of encoded video frames received in a third segment of the plurality of segments.

10. The method of claim 1, wherein:
the at least one supplementary video frame is a precomputed black frame.

11. The method of claim 1, wherein:
the at least one supplementary video frame is an IDR frame replicated from a first IDR frame of a subsequently received third set of the plurality of encoded video frames received in a third segment of the plurality of segments.

12. The method of claim 1, wherein the plurality of segments include a plurality of audio frames and a supplementary audio frame for every at least one supplementary video frame.

13. The method of claim 1, wherein adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered comprises:
comparing the amount of encoded video frames currently buffered to a second threshold; and
subtracting at least one of the second set of the plurality of video frames if the amount of encoded video frames currently buffered is above a second threshold.

14. An apparatus for correcting a time base of a video stream, the video stream compiled from video data received in a plurality of segments having a plurality of video frames encoded according to an adaptive bit rate protocol, comprising:
a processor;
a memory, communicatively coupled to the processor, the memory storing processor instructions comprising processor instructions for:
(a) receiving a first segment of the plurality of segments, the first segment having a first set of the first plurality of encoded video frames;
(b) buffering the received first set of the plurality of encoded video frames in a buffer;
(c) providing the buffered first set of the plurality of encoded video frames for processing to compile at least a portion of the video stream;
(d) receiving a second segment of the plurality of segments, the second segment having a second set of the first plurality of encoded video frames;
(e) determining an amount of encoded video frames currently buffered; and
(f) adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered before processing the second set of the plurality of encoded video frames to compile at least a second portion of the video stream.

15. The apparatus of claim 14, wherein:
the instructions further comprise instructions for determining that the second segment of the plurality of segments comprises at least a portion of an advertisement; and
wherein the instructions perform step (f) only if the second segment of the plurality of segments comprises at least a portion of the advertisement.

16. The apparatus of claim 14, wherein the instructions for adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered comprise instructions for:
comparing the amount of encoded video frames currently buffered to a first threshold; and
adding the at least one video frame if the amount of encoded video frames currently buffered is below a first threshold.

17. The apparatus of claim 14, wherein each of the plurality of encoded video frames of the video stream comprises a time stamp, and the instructions further comprise adjusting the time stamp of the each of the at least one supplementary encoded video frames.

18. The apparatus of claim 14, wherein:
the at least one supplementary video frame is a precomputed black frame.

19. The apparatus of claim 14, wherein the instructions for adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered comprise instructions for:
comparing the amount of encoded video frames currently buffered to a second threshold; and
subtracting at least one of the second set of the plurality of video frames if the amount of encoded video frames currently buffered is above a second threshold.

20. An apparatus for correcting a time base of a video stream, the video stream compiled from video data received in a plurality of segments having a plurality of video frames encoded according to an adaptive bit rate protocol, comprising:
means for receiving a first segment of the plurality of segments, the first segment having a first set of the first plurality of encoded video frames;
means for buffering the received first set of the plurality of encoded video frames in a buffer;
means for providing the buffered first set of the plurality of encoded video frames for processing to compile at least a portion the video stream;
means for receiving a second segment of the plurality of segments, the second segment having a second set of the first plurality of encoded video frames;
means for determining an amount of encoded video frames currently buffered; and
means for adding the second set of the first plurality of encoded video frames and at least one encoded supplementary video frame to the buffer, or subtracting at least one video frame of the second set of the first plurality of video frames and adding the resulting second set of the first plurality of video frames to the buffer according to the determined amount of encoded video frames currently buffered before processing the second set of the plurality of encoded video frames to compile at least a second portion of the video stream.
